(19) United States
(12) Patent Application Publication
(10) Pub. No.: US 2014/0054885 A1
(43) Pub. Date: Feb. 27, 2014

(54) C-AXIS RING FOR A MACHINE TOOL

(71) Applicants: Peter L. Mischler, Rockton, IL (US); Robert G. Mansfield, Cincinnati, OH (US)

(72) Inventors: Peter L. Mischler, Rockton, IL (US); Robert G. Mansfield, Cincinnati, OH (US)

(73) Assignee: FIVES MACHINING SYSTEMS, INC., Fond du Lac, WI (US)

(21) Appl. No.: 14/117,198

(22) PCT Filed: May 17, 2012
(86) PCT No.: PCT/US12/38334

§ 371 Date: Nov. 12, 2013

Related U.S. Application Data
(60) Provisional application No. 61/486,936, filed on May 17, 2011.

(51) Int. Cl. F16L 27/08

(52) U.S. Cl. CPC F16L 27/0804
USPC 285/272

(57) ABSTRACT

A rotary joint for a fluid is in the form of a hollow ring having an upper half and a lower half that are rotatable relative to one another in an X-Y plane around a C-axis. An inlet tube admits fluid to the ring and an outlet tube exhausts fluid from the ring. Both the inlet tube and the outlet tube are displaced from the C-axis. An inlet elbow is positioned in the hollow ring and has a rounded bend in the interior of the ring that directs fluid around the circumference of the ring. An outlet manifold that is tangential to the outer surface of the ring is coupled to the outlet tube.

This application claims the benefit of U.S. Provisional Application Ser. No. 61/486,936 filed on May 17, 2011, the entire disclosure of which is incorporated herein.

### FIELD

The device relates to a rotary union that is used to evacuate coolant and debris from the workzone of a machine tool having continuous rotation in the C-axis.

### BACKGROUND

Machine tools may be equipped with a vacuum device to suck coolant and debris away from the workzone. Machine tools with A/C axis Heads and continuous rotation in the C-axis require a rotary joint capable of infinite rotation. One approach to such a rotary joint is to install the vacuum on the centerline of C-axis and have a simple rotary joint between two concentric pipes. While this is the simplest way to create the rotary joint, it is often impractical due to other design considerations and space constraints. Another approach is to create a ring shaped outlet manifold or plenum around the outside diameter of the C-axis with fixed and rotary halves. The disclosed device is an improved form of such a rotary union.

Known vacuum rings that allow C-axis or similar rotation in a machine tool are typically ring shaped plenums or tanks with substantially square inlets and outlets. The square corners of the inlets and outlets cause vena-contracta that restrict the effective diameter of the tubing and add resistance to the flow of the air to the vacuum. The square inlets and outlets also fail to direct the air and debris in a continuous path around the ring, causing areas of eddy currents that allow debris to fall out of the airstream and making it difficult to keep the debris moving to its destination.

It would thus be desirable to provide a C-axis rotary joint for a fluid with inlet and outlet designs that minimize the restriction to the flow into and out of the rotary joint.

It would also be desirable to keep fluid flow directed through the joint and the debris it is carrying suspended and moving in the proper direction.

### BRIEF DESCRIPTION OF THE DRAWINGS

FIG. 1 is a top view of a rotary joint.

FIG. 2 is a perspective view of a rotary joint.

FIG. 3 is a sectional view taken along line 3-3 of FIG. 1.

FIG. 4 is a perspective sectional view of a rotary joint showing portions of the inlet duct and outlet manifold.

FIG. 5 is a perspective view partly in section taken along line 5-5 of FIG. 2.

FIG. 6 is a perspective view partly in section of a rotary joint showing the flow pattern inside the rotary joint for one position of the rotary joint.

FIG. 7 is a perspective view partly in section of a rotary joint showing the flow pattern inside the rotary joint for another position of the rotary joint.

FIG. 8 is sectional view of a rotary joint showing the outlet manifold overlapping the inlet elbow and tube.

FIG. 9 is a perspective view of an alternate embodiment of a rotary joint.

### DESCRIPTION OF THE PREFERRED EMBODIMENT

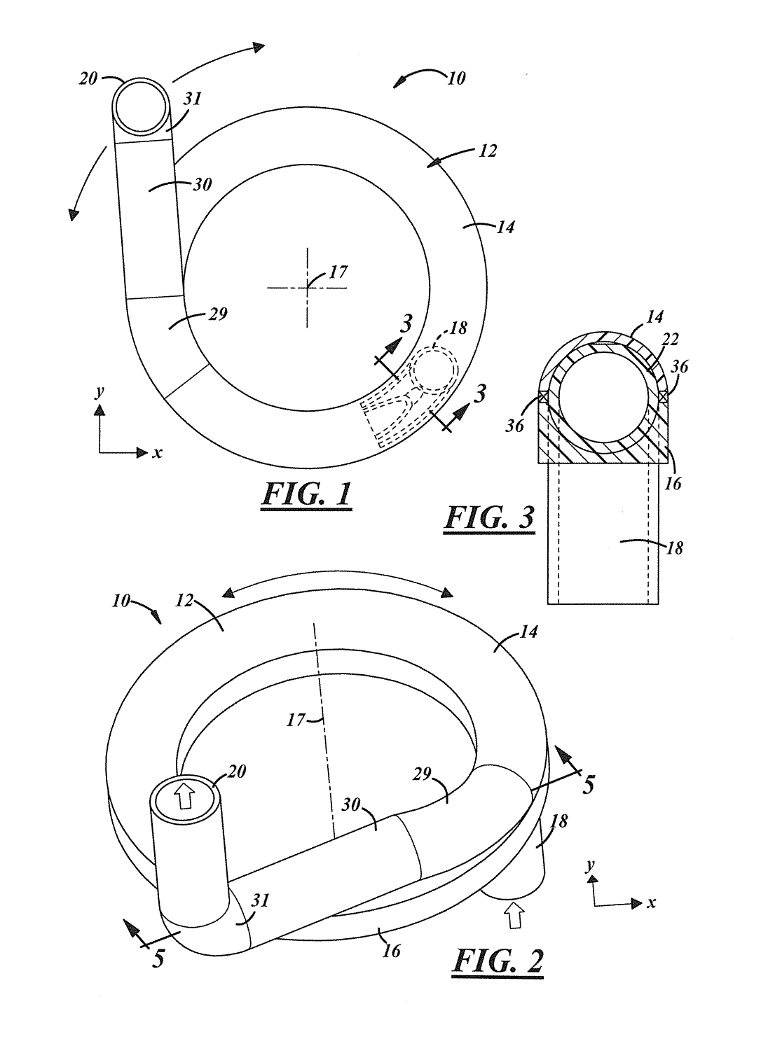

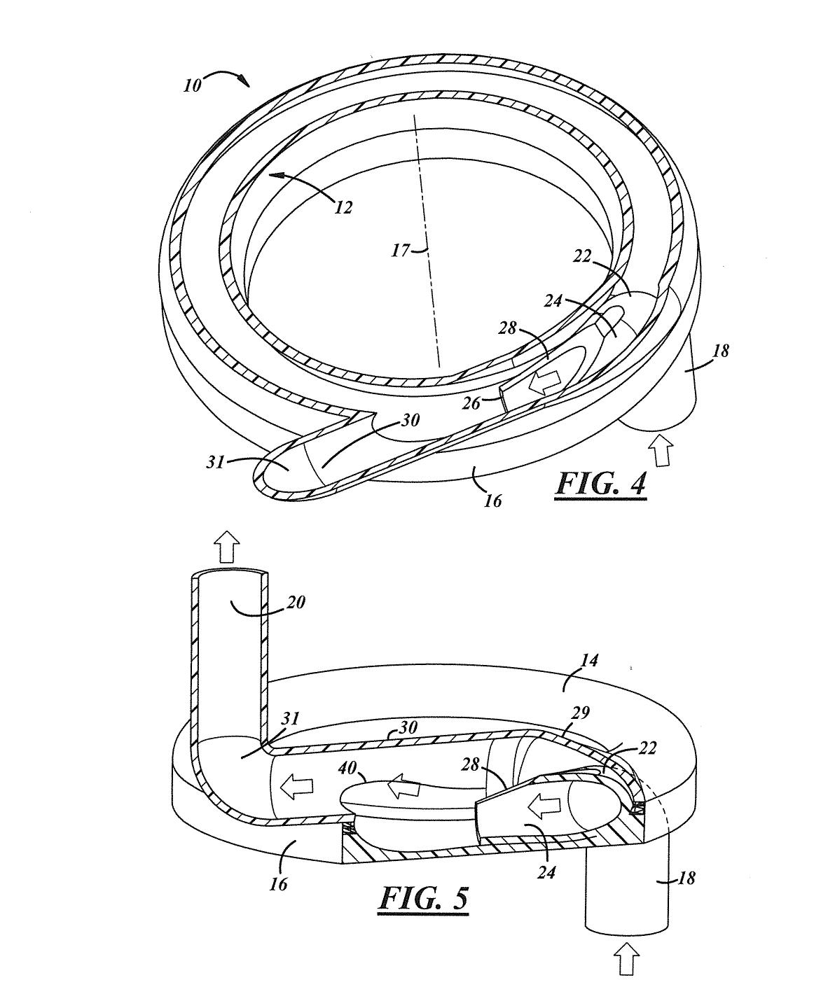

Turning now to the drawing figures, FIG. 1 is a top view of a rotary joint generally designated by the reference numeral 10. The rotary joint 10 is in the shape of a ring 12 with a hollow interior. A round inlet tube 18 shown in phantom is connected to the bottom half 16 of the ring and leads to an interior inlet elbow 22 as best seen in FIGS. 4-8. A round outlet tube 20 is connected to the top half 14 of the ring by an outlet manifold header 29, an outlet manifold 30, and an outlet inlet elbow 31. The top half 14 of the ring is infinitely rotatable in the X-Y plane in either the clockwise or counterclockwise directions with respect to the bottom half 16 of the ring around a C-axis of rotation 17. Both the inlet tube 18 and the outlet tube 20 are displaced from the C-axis of rotation 17, and are perpendicular to the X-Y plane.

FIG. 2 is a perspective view of a rotary joint of FIG. 1. The inlet tube 18 intersects the bottom half 16 of the ring at a right angle, and the outlet tube 20 is at right angles to the plane of the top portion 14 of the ring. The outlet manifold header 29 that couples the outlet manifold 30 to the top portion 14 of the ring is swept away from the top portion 14 ring and provides additional clearance within the ring for the inlet elbow 22 as best seen in FIGS. 5-8. The outlet tube 20 is connected to the outlet manifold 30 by the outlet elbow 31. In an alternate design, the outlet tube may be swept away from the side of the ring 12 instead of from the top of the ring as shown.

FIG. 3 is a sectional view taken along line 3-3 of FIG. 1. The top half 14 of the ring is separated from the bottom half 16 of the ring by a pair of ring bearings and seals 36 that permits relative rotary motion between the top and the bottom of the ring in the X-Y plane while preventing leakage of the fluid contained within the interior of the ring. The interior of the top half 14 of the ring is shaped to conform to the top of the inlet elbow 22 for those rotary positions of the ring where the outlet manifold header 29 is not positioned over the inlet elbow 22.

FIG. 4 is a perspective sectional view of a rotary joint showing portions of the inlet and outlet structures. The inlet tube 18 is coupled to the rounded inlet elbow 22 that is positioned in the bottom half 16 of the ring. The inlet elbow 22 is connected to an inlet injector 24, and the inlet elbow and inlet injector substantially fill interior of the ring as best seen in FIG. 3. The interior of the inlet elbow 22 is smooth and curved to avoid the creation of eddy currents in the inlet flow. The inlet elbow 22 and the inlet injector 24 direct the inlet flow of fluid in a clockwise direction around the circumference of the ring 12 so that the fluid flow is smooth around the interior of the ring. The elements of the device may also be arranged to direct the flow in the counterclockwise direction. The outlet end 26 of the inlet injector 24 is cut away at an angle relative to the X-Y plane to form a bevel opening 28.

FIG. 5 is a perspective view partly in section taken along line 5-5 of FIG. 2 showing the interior of the rotary joint. The outlet manifold 30 and the outlet manifold header 29 wrap over a portion of the top of the ring in a clockwise direction toward the outlet tube 20 and are oriented to receive fluid that is flowing clockwise in the ring from the inlet injector 24. When the top and bottom halves of the ring are in the relative positions shown, the outlet manifold 30 and the outlet manifold header 29 overlap the inlet elbow 22 and the inlet injector 24. The bottom portion of the outlet manifold 30 is cut away to form an outlet manifold entrance 40 to allow flow from the bottom portion of the ring to enter the outlet manifold 30 and exit through the outlet tube 20.

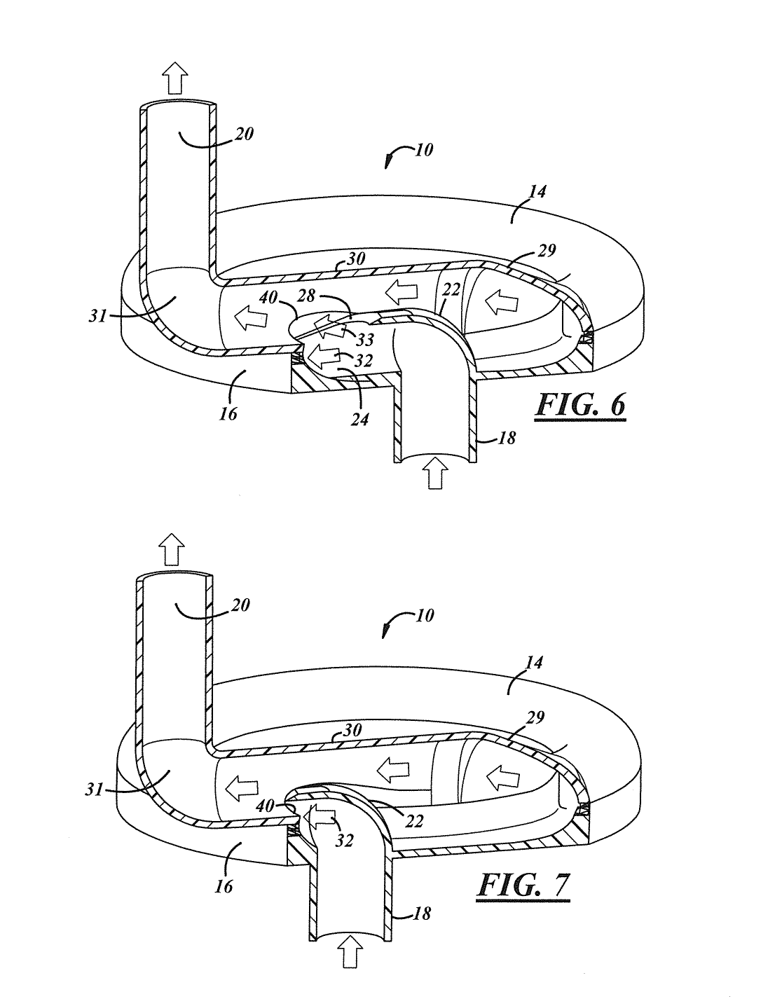

FIG. 6 is a perspective view partly in section of the rotary joint 10 showing the flow pattern for one position of the rotary joint in which the outlet manifold entrance 40 is slightly downstream from the bevel opening 28. In this position, flow that enters the ring from the inlet injector 24 is divided between a first flow path generally indicated by the arrow 32 that proceeds in a clockwise direction around the bottom 16 of the ring and a second flow path generally indicated by the arrow 33 that proceeds through the outlet manifold entrance 40 into the outlet manifold 30. The clockwise flow in the first flow path 32 in the bottom 16 of the ring flows around the ring, passes over the top of the inlet elbow 22, over the inlet injector 24, and enters the outlet manifold 30. The flow in the second flow path 33 that passes through the outlet manifold entrance 40 passes directly to the outlet tube 20 without circling around the ring. The bevel opening 28 on the inlet injector 24 allows the fluid flow path to switch from almost 360 degrees around the ring 12 using the first flow path 32 as shown in FIG. 7 to as little as 10 degrees using the second flow path 33 as the top 14 of the ring rotates relative to the bottom 16 and the outlet manifold entrance 40 moves to a downstream position relative to the bevel opening 28 as shown in FIG. 6. Both the inlet elbow 22 and the outlet elbow 31 are rounded and have smooth interior surfaces to promote the flow of fluid therethrough, and avoid the formation of eddy currents. The outlet manifold 30 and the outlet manifold header 29 are swept away from the ring 12 to allow the fluid flow to wrap around the ring and over the inlet elbow 22 when the inlet tube 18 and the outlet tube 20 are nearly aligned angularly as also shown in FIGS. 6 and 7. The outlet manifold 30 is tangential to the top outer surface of the ring 12.

FIG. 7 is a perspective view partly in section showing the flow pattern for another position of the rotary joint 10 in which the outlet manifold entrance 40 is aligned with or upstream from the bevel opening 28. In this position, there is no flow through the second flow path 33 through the outlet manifold entrance 40 because of the relative positions of the outlet manifold entrance and the bevel opening 28. The inlet elbow 22 does not create a flow restriction to the clockwise flow in the ring because of the enlarged dimensions of the outlet manifold header 29 and the outlet manifold 30. As a result, substantially all of the flow is in the first flow path 32 around the ring and over the top of the inlet elbow 22 before entering the outlet manifold 30 and the outlet tube 20. The combination of the bevel opening 28 and the outlet manifold entrance 40 allows the ring 10 to maintain continuous flow from the inlet tube 18 to the outlet tube 20 in all rotational positions of the top 14 of the ring relative to the bottom 16 of the ring.

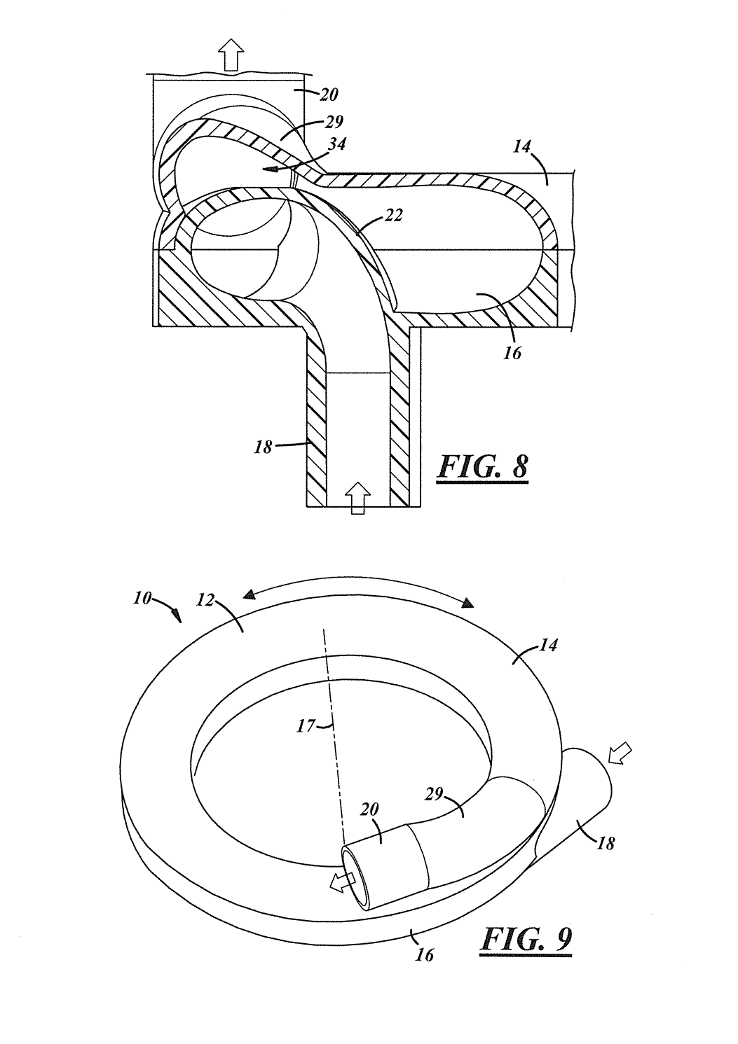

FIG. 8 is sectional view of the rotary joint showing the outlet manifold header 29 overlapping the inlet elbow 22. The outlet manifold header 29 is dimensioned to leave a fluid passage 34 between the inlet elbow 22 and the outlet manifold header when the outlet manifold header is directly over the inlet elbow.

FIG. 9 is a perspective view of an alternate embodiment of a rotary joint in which the inlet tube 18 may be parallel to the X-Y plane rather than perpendicular to it. Similarly, the outlet tube 20 may be parallel to the X-Y plane rather than perpendicular to it.

Having thus described the invention, various modifications and alterations will be apparent to those skilled in the art, which modifications and alterations are intended to be within the scope of the device as defined by the appended claims.

1. A rotary joint for a fluid comprising:
a hollow ring having a top half and a bottom half that are rotatable relative to one another in an X-Y plane around a C-axis;
an inlet tube for admitting fluid to the ring;
an outlet tube for exhausting fluid from the ring, wherein both the inlet tube and the outlet tube are displaced from the C-axis;
an inlet elbow positioned in the hollow ring having a rounded bend in the interior of the ring that directs fluid around the circumference of the ring; and,
an outlet manifold coupled to the outlet tube, the outlet manifold being tangential to the outer surface of the ring.

2. The rotary joint of claim 1 further comprising:
an inlet injector coupled to the end of the inlet elbow in the interior of the ring, the inlet injector directing fluid flow in a predetermined direction in the interior of the ring.

3. The rotary joint of claim 2 further comprising:
a bevel opening formed on the inlet injector, the bevel opening allowing the fluid flow path in the ring to switch from almost 360 degrees around the ring to as little as 10 degrees as the top half of the ring rotates relative to the bottom half of the ring and the outlet manifold passes over the bevel opening.

4. The rotary joint of claim 2, wherein the inlet elbow and the inlet injector substantially fill the interior of the ring.

5. The rotary joint of claim 1 further comprising:
an outlet manifold header mounted on the top half of the ring, the outlet manifold header coupling the top half of the ring to the outlet manifold.

6. The rotary joint of claim 5, wherein the inlet elbow projects into the top half of the hollow ring and wherein the outlet manifold header is swept away from the top half of the ring to provide a fluid passage between the inlet elbow and outlet manifold header when the outlet manifold header is directly over the inlet elbow.

7. The rotary joint of claim 2 wherein the outlet manifold is arranged to intercept fluid flowing in the said predetermined direction in the ring.

8. The rotary joint of claim 1 further comprising:
an outlet manifold entrance formed in the bottom surface of the outlet manifold, the outlet manifold entrance in one position of the rotary joint dividing the flow that enters the ring into a first flow path that proceeds around the bottom half of the ring and a second flow-path that flows through the outlet manifold entrance into the outlet manifold.

9. The rotary joint of claim 8 wherein the flow that is in the first flow path flows around the ring and passes over the top of the inlet elbow before entering the outlet manifold; and wherein the flow that is in the second flow path flows directly to the outlet manifold and outlet tube without circling the ring.

10. The rotary joint of claim 8:
wherein in one position of the ring the flow that enters the ring cannot enter the outlet manifold entrance because of the relative position of the outlet manifold entrance and the bevel opening on the inlet injector, and wherein in the said one position substantially all of the flow that enters the ring flows in a first flow path around the circumference of the ring and passes over the top of the inlet elbow without any appreciable restriction before entering the outlet manifold header, the outlet manifold, and the outlet tube.

11. The rotary joint of claim 5 wherein the outlet manifold header is dimensioned to leave a fluid passage between the inlet elbow and the outlet manifold header when the outlet manifold header is in an overlapping relationship with the inlet elbow.

12. The rotary joint of claim 1 wherein the inlet elbow is curved to avoid the creation of eddy currents in the inlet flow.

13. the rotary joint of claim 1 wherein the inlet tube is perpendicular to the X-Y plane.

14. The rotary joint of claim 1 wherein the outlet tube is perpendicular to the X-Y plane.

15. The rotary joint of claim 1 wherein the inlet tube is parallel to the X-Y plane.

16. The rotary joint of claim 1 wherein the outlet tube is parallel to the X-Y plane.
